(19) United States
(12) Patent Application Publication
(10) Pub. No.: US 2022/0068077 A1
(43) Pub. Date: Mar. 3, 2022

(54) AUTOMATED PERSONAL PROTECTIVE EQUIPMENT DISPENSER

(71) Applicants: Paula Mims, Lakeland, FL (US); Tom Mims, Lakeland, FL (US)

(72) Inventors: Paula Mims, Lakeland, FL (US); Tom Mims, Lakeland, FL (US)

(21) Appl. No.: 17/412,245

(22) Filed: Aug. 25, 2021

Related U.S. Application Data
(60) Provisional application No. 63/070,293, filed on Aug. 26, 2020.

(51) Int. Cl. G07F 9/00

(52) U.S. Cl. CPC G07F 9/009

(57) ABSTRACT

A machine that comprises a housing capable of containing a supply of at least one type of persona protective equipment, a motion sensor, a control module, and at least one operably connected means for moving at least one item of personal protective equipment. Personal protective equipment includes masks, gloves, face shields, and gowns.

This application claims the benefit of U.S. Provisional Application 63/070291

### BACKGROUND OF THE INVENTION

The touchless dispensing of useable goods has been highlighted during the current COVID19 pandemic although healthcare providers have long known the value. Even in places like public restrooms patrons have learned the value of not sharing towels and have recognized the need for touchless soap and antibacterial liquid dispensing. Appliances have moved to motion detected use for water turn on and off. Slight touch appliances, such as faucets, are also appearing more frequently in home and residential use.

In the current environment in which potentially infected surfaces can cause infection spread to a tremendous magnitude, the need for touchless dispensing has never been greater. Healthcare workers, in particular, who must frequently use a new disposable mask have to touch a larger stack of these items to coax a one-use item from a box. An example of such a dispenser is disclosed in U.S. application Ser. No. 13/581,989, Published as US2012/0325843 A1.

Although the automatic dispensing of liquids like hand sanitizer and soap has become widely used, the immediate and touchless automatic dispensing of disposable and multi-use masks, gloves, face shields and gowns is a necessary next step to the continued effort to maintain sterilization or at the very least reduce the spread of germs.

An example of a motion-activated machine for selling solid items is found in U.S. Pat. No. 9,245,403B2. It incorporates a dispensing portion, a motion sensor, and a control module, all controlled by a receiver module that receives confirmation of payment through an application on a mobile device. Another is disclosed in U.S. Pat. No. 9,959,530B2; it is also a vending machine which is distinct from the present invention.

An example of a dispenser of personal protective equipment is found in U.S. application Ser. No. 09/896,918, published under No. US20020040912A1. This dispenser is designed for dispensing masks and gloves, but, having no motion detection system nor a means for moving items, is not touchless.

Not only would healthcare facilities benefit from this mechanism but schools, businesses, sporting events, entertainment venues, to name a few, would be positively affected. The benefit to reducing germ spread is well-documented, and even on an anecdotal level, makes tremendous sense for any area when and where disposable or multi-use masks, gloves, face shields, and gowns are needed. Thus, there remains a need for a motion-activated dispenser that is not a vending machine, but provides a touchless experience while providing much-needed personal protective equipment.

### SUMMARY OF THE INVENTION

The present invention is a machine that comprises a housing capable of containing a supply of at least one type of personal protective equipment, which may be masks, gloves, gowns, or other small to medium-sized devices (all “PPE”), or packaged kits containing more than one type of PPE. The preferred type of PPE for the machine of the present invention is masks. The housing also contains at least one moving means capable of moving one item of PPE or a kit of multiple PPEs (“dispensing device”) from said supply to an opening in the housing where it may be collected by the user, all operably connected to the housing. It further contains at least one motion sensor and a control module, which work together to send a signal to the correct dispensing device to activate it to move the selected item. The machine necessarily contains an opening for the items to be made available to the user by the dispensing device.

The advantage of the present invention is that the items or kits of PPE are not resting in the open air but are protected by the housing from droplets or particles containing pathogens, such as virus particles, that may be present in the air. This is especially important in medical treatment venues such as doctors' offices and hospitals, and it is more important in locations in which patients with communicable diseases are waiting or being treated such as hospital emergency rooms and intensive care units.

### DETAILED DESCRIPTION

The motion sensor is configured so as to release the signal to the control module to activate the dispensing device when motion is detected in a space relatively close to the machine. Optionally, there are multiple motions sensors encased in the housing, each controlling the dispensing device for a different type of PPE. There are multiple examples of such a motion sensor available and may be used by one of ordinary skill in building the machine. One such sensor is described in U.S. Pat. No. 9,245,403B2, incorporated herein by reference.

An important feature of this device is the means to move a single item of PPE to the opening in the machine for retrieval by the user. This moving mechanism may be any of several known types, such as an arm, a stick, or a roller, that further comprises a means for grasping the item and releasing it into the opening. This grasping means may be, for example, a pincher or pad coated in a releasable adhesive. The grasping means pinches or adheres to the item of PPE that is the lowest or highest in the supply. If a pincher is used, it is preferable under the control of the controller module so as to release an item into the opening when in position.

The moving mechanism is arranged so that it pulls the item away from the rest of the supply and releases it into the opening. The moving mechanism may optionally flip the item over to allow its release, particularly if the grasping means is a releasable adhesive pad. If the machine is made to house more than one type of PPE, the moving means may be configured so as to move the one type of PPE according to the signal sent by the control module. Optionally, there may be multiple moving mechanisms, one for each type of PPE to be housed and dispensed by the machine. The one or more moving mechanisms are operably connected to the housing or another part of the machine.

Optionally, items of PPE are separately packaged but connected to one another so as to aid in replenishing the supply in the machine. The individual items would be arranged either in a stack or in a roll. In this example, the moving means would grasp the item at the end of the stack or roll that is closed to the opening. The item would then be moved into the opening making it available to the user who would tear the perforations to release the item. For ease of use, the supply of PPE is composed of separately packaged items or separately packaged kits of multiple PPE items.

The housing may be made of any suitable material for protecting the internal components from being accidentally disabled by passersby. For example, it might be a stiff cardboard with metal or plastic parts used to hold the dispensing means and the motion sensor. Preferably, it would be made of a metal composition, preferably steel, allowing even more protection to the supplies of PIPE. The size of the housing can vary from small so as to hold a moderate number of small items of PPE to large so as to hold gowns and optionally other types of PPE.

The controller module is an electronic device that receives the signal from the motion sensor and relays the signal to the moving means, causing it to move an item of PPE to be moved into an opening of the housing. If more than one type of PPE is dispensed by the machine of the present invention, the controller module also includes the means for a selection of type of PPE by the user, and it signals the dispensing device to select and move the correct item. The controller can be of varying size, but is preferably small so as not to leave more of the housing for the supply or supplies of PPE items.

The components of the present invention may be selected by those of ordinary skill in the art of assembling dispensing machines, adjusting them for the sizes and shapes and the item, items or kits of PPE for which it is intended.

The references cited herein, to the extent that they provide exemplary mechanical, procedural, or other details supplementary to those set forth herein, are specifically incorporated herein by reference.

What is claimed is:

1. A machine for dispensing items of personal protective equipment comprising: a housing, a space for containing at least one supply of personal protective equipment; an operably connected means of moving a single item of personal protective equipment that includes a grasping means; an electronic control module; and at least one motion detector to send signals to said electronic control module; wherein the personal protective equipment is masks, gloves, gowns, or face shields or a combination of two or more of these.

2. The machine of claim 1 wherein the housing is made of a metal.

3. The machine of claim 1 wherein the housing is configured to contained more than one type of personal protective equipment or combinations of multiple types of personal protection equipment.

4. The machine of claim 1 wherein the moving means comprises a mechanism that is an arm, a stick, or a roller.

5. The machine of claim 4 wherein the grasping means is selected from a pinching device and an adhesive device.

6. The machine of claim 1 wherein the housing is configured to house a supply of personal protective equipment items arranged in a stack of individual packages.

7. The machine of claim 1 wherein the housing is configured to house a supply of personal protective equipment items wherein the items are individually packaged but connected to each other by perforated sides.

8. The machine of claim 1 wherein the sole supply of personal protective equipment is comprised of masks.
